(19) United States
(12) Patent Application Publication
(10) Pub. No.: US 2005/0045656 A1
(43) Pub. Date: Mar. 3, 2005

(54) Beverage container with candy dispenser

(76) Inventors: Adam Jav Veverka, Hoboken, NJ (US); Howard Douglas Shatz, Hoboken, NJ (US)

Correspondence Address: Howard D. Shatz, Apt. 814, 333 River St., Hoboken, NJ, 07030, US

(21) Appl. No.: 10/654,515

(22) Filed: Sep. 2, 2003

(51) Int. Cl. B67D 5/60

(52) U.S. Cl. 222/133; 222/183; 222/323; 222/325; 222/465.1

(57) ABSTRACT

A beverage container comprising a container body having one or more side walls and a bottom wall defining a storage area and an open end for receiving a beverage to be contained within the container body. The beverage container has a handle coupled to the one or more side walls having a hollow compartment for storing one or more pellets within the handle. The beverage container also has a dispensing aperture in the handle for allowing the dispensing of the one or more pellets, a shutter disposed in the handle aligned between the compartment and the aperture to prevent the dispensing of the one or more pellets, and an actuator coupled to the shutter. The actuator may be depressed to cause the shutter to change position to allow dispensing of the one or more pellets from the compartment within the handle.

### BACKGROUND OF THE INVENTION

1. Field of the Invention

The present invention relates to a beverage container having a handle configured to allow the storing and dispensing of pellets. More specifically, the present invention relates to a coffee mug having a handle configured to allow the loading, storing, and dispensing of breath freshening mints or gum.

2. Description of Related Art

It is very common for people to carry beverage containers, such as coffee mugs or thermoses back and forth to work or school or while traveling. People often will stop to purchase or refill their beverage containers at local coffee shops, markets, restaurants, and rest areas on the highway. After drinking a beverage, such as coffee or tea, a person will often wish to freshen their breath to rid the taste and bad breath that may be associated with such beverages. This is especially true since coffee and tea is often consumed on the way to work in the morning, after eating a meal at night, or in other public environments. A common manner for people to freshen their breath in public is through the use of mints or gum. People often purchase and carry around dispensers or packages containing mints or gum to freshen their breath.

Accordingly a need exists for a beverage container that contains therein a dispenser, such as in the handle, to store mints or gum to allow a person to immediately access the mints or gum to freshen their breath upon finishing the beverage contained in their beverage container. Additionally, it would be even more desirable to provide a coffee mug, whereby a person could refill their beverage and purchase a refill cartridge containing mints or gum, and load the refill cartridge into the handle of the coffee mug periodically to allow dispensing of the mints or gum to the person.

### 3. SUMMARY OF THE INVENTION

The foregoing, as well as other, needs are satisfied by the present invention by providing a beverage container having a handle that is configured to allow the storing and dispensing of pellets.

One embodiment of the invention directed to a beverage container comprising a container body having one or more side walls and a bottom wall defining a storage area and an open end for receiving a beverage to be contained within the container body. The beverage container has a handle, coupled to the one or more side walls, having a compartment for storing one or more pellets within the handle. The beverage container also has a dispensing aperture in the handle for allowing the dispensing of the one or more pellets and a shutter disposed in the handle aligned between the compartment and the aperture to prevent the dispensing of said one or more pellets. The shutter is configured to open to allow the dispensing of the one or more pellets and close to prevent the dispensing of the one or more pellets from the compartment within the handle.

Another embodiment of the invention directed to a beverage container comprising a container body having one or more side walls and a bottom wall defining a storage area and an open end for receiving a beverage to be contained within the container body. The beverage container has a handle, coupled to the one or more side walls, having a compartment for storing one or more pellets within the handle. The beverage container also has a dispensing aperture in the handle for allowing the dispensing of the one or more pellets and a shutter disposed in the handle aligned between the compartment and the aperture to prevent the dispensing of said one or more pellets. An actuator is coupled to the shutter. The actuator may be depressed to cause the shutter to change position to allow dispensing of the one or more pellets from the compartment within the handle.

The invention will next be described in connection with certain exemplary embodiments; however, it should be clear to those skilled in the art that various modifications, additions, and subtractions can be made without departing from the spirit or scope of the claims.

### BRIEF DESCRIPTION OF THE DRAWINGS

The following drawing figures, which are included herewith and form a part of this application, are intended to be illustrative examples and not limiting of the scope of the present invention.

FIGS. 1 and 1A are side views of a beverage container according to one embodiment of the present invention.

FIGS. 2-7 are side views of the handle of a beverage container according to embodiments of the present invention.

### DETAILED DESCRIPTION OF CERTAIN EMBODIMENTS

Certain embodiments of the present invention will now be described in greater detail with reference to the aforementioned figures.

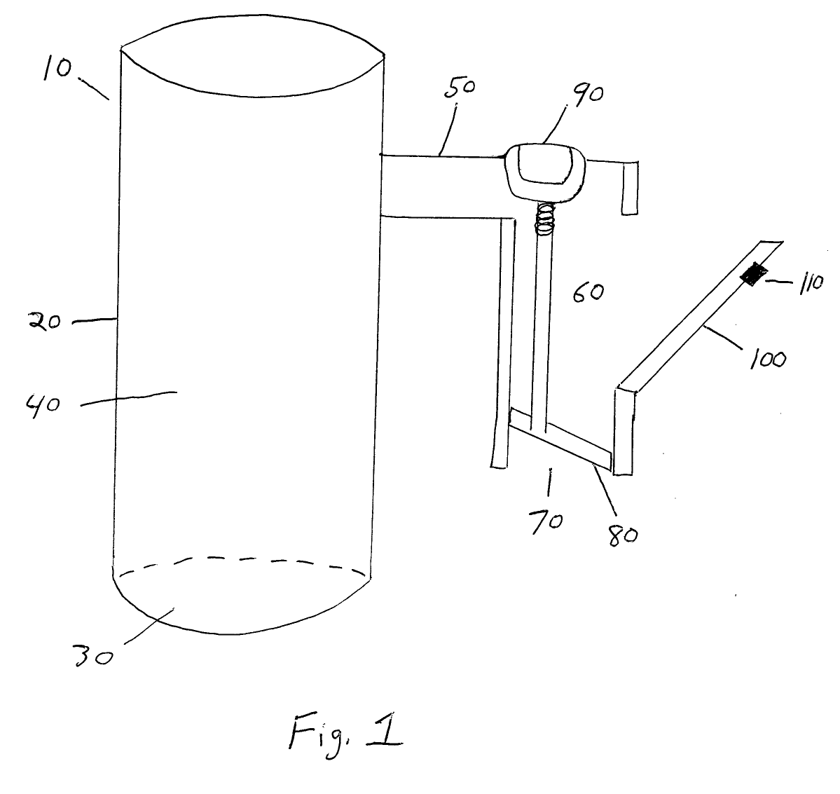

FIG. 1 is a side view of a beverage container according to one embodiment of the present invention. The beverage container shown in FIG. 1 is the coffee mug or thermos, and includes a cylindrical container body 10 having a cylindrical side wall 20 and a circular bottom wall 30, a cylindrical storage area 40, a handle 50 having a hollow compartment 60, a dispensing aperture 70, a shutter 80, an actuator 90, a loading door 100.

In this embodiment of the present invention, a container body 10 has a cylindrical side wall 20 and a circular bottom wall 30 defining a cylindrical storage area 40. The cylindrical side wall 20 also forms a circular open end at the top of the container body 10. A beverage, such as coffee, tea, or a blended drink, is received or poured through the open top end of the container body 10 and stored in the storage area 40. The size of the container body 10 may be varied to allow for the storage of different amounts of a beverage, by varying the length and width of the side wall 20 and the circumference of the bottom wall 30 and top end of the container body 10. This will allow a company to sell beverage containers and beverages of different sizes to customers. Additionally, a removable cover may fit into, onto, or around the top end of the container body 10 after the beverage has been poured into the storage area 40 of the container body 10. The cover may have an aperture disposed within the cover to allow the user to drink the beverage from the beverage container without removing the cover.

Although this embodiment defines the container body 10 as cylindrical, in alternate embodiments, the container body 10, through its one or more side walls 20 and bottom wall 30, may form any shape that is suitable for storing a beverage. Further, the size of the container body 10 and cover may be varied to allow for the storage of different amounts of a beverage, by varying the dimensions of the one or more side walls 20, bottom wall 30, and top end of the container body 10. Further, the word beverage shall not be limit to only drinkable liquids, but shall also include foods such as soup, chili, or ice cream and drinks such as shakes, smoothies, and any other food or drink that may be stored in a beverage container.

A handle 50 is coupled to the cylindrical side wall 20 to allow the user to hold the beverage container. The handle 50 has a hollow compartment 60 for storing pellets, such as breath freshening mints, gum, candy, or any other edible object, within the handle 50. The user may load the pellets into the hollow compartment 60 within the handle 50 by opening a loading door 100, via a hinge, on the outside of the handle 50, which exposes the hollow compartment 60. A tab 110 extends from the loading door 100 to allow the user to open and close the loading door 100. After the pellets have been loaded into the hollow compartment 60 of the handle 50, the user then closes the loading door 100 on the handle 50 and snap fits it into place, as shown in FIG. 1A, to keep the pellets within the hollow compartment 60 of the handle 50. It is preferable that the loading door 100 open in a direction away from the container body 10 to facilitate easier loading of the pellets. However, in alternate embodiments the loading door 100 may open in any direction. Additionally, in alternate embodiments, the loading door 100 may be located anywhere on the handle 50 that would allow the loading of pellets into the hollow compartment 60, and the loading door 100 may open via a variety of methods, including, but not limited to, sliding up and down along the outside of the handle 50 to expose the hollow compartment 60.

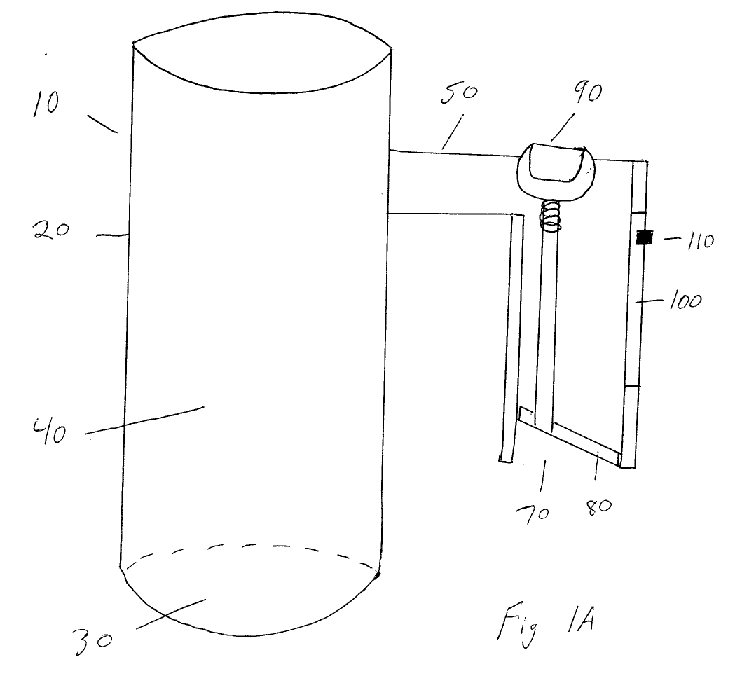

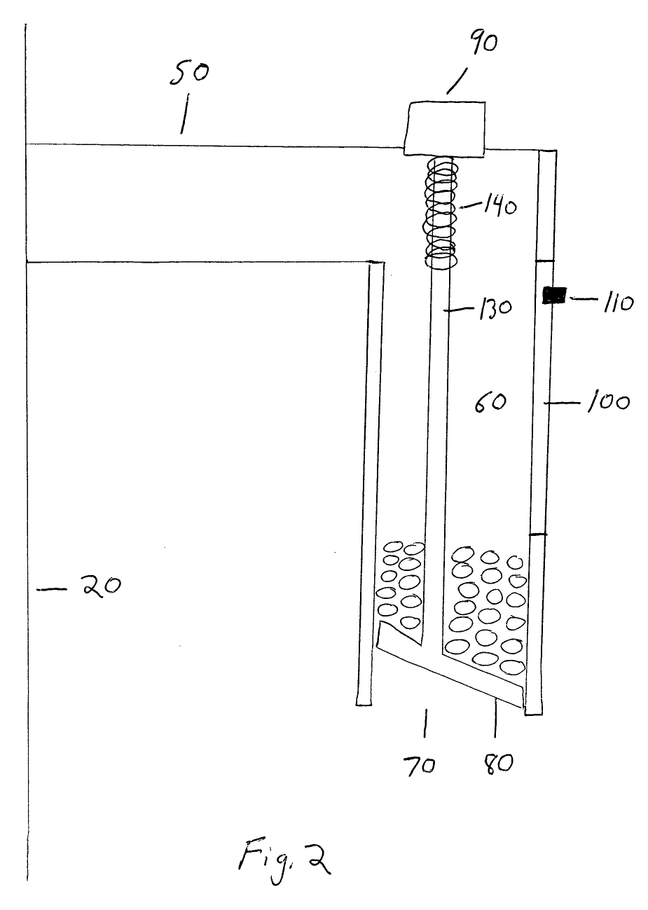

A dispensing aperture 70 is located at the bottom of the handle 50 to allow the user to dispense the pellets stored in the hollow compartment 60 within the handle 50. In the non-activated mode of the present embodiment, as show in FIG. 2, a slanted shutter 80 is disposed, in the handle 50, aligned between the bottom of the hollow compartment 60 and the dispensing aperture 70 to prevent the pellets from being dispensed through the dispensing aperture 70. An actuator 90, such as a button, located at the top of the handle 50 is coupled to the shutter 80 via a lever 130 located within the handle 50. A spring 140 is also coupled to the actuator 90 and fits around the lever 130. The spring 140 is configured to compress to allow the user to press down on the actuator 90. When the user presses down on the actuator 90, the lever 130 descends and forces the slanted shutter 80 below the dispensing aperture 70 to create an opening to allow the pellets to be dispensed from the hollow compartment 60 to the user through the dispensing aperture 70 at the bottom of the handle 50. The present embodiment is now in the activated mode, as shown in FIG. 3. When the user ceases to press down on the actuator 90, the spring 140 decompresses, and forces the actuator 90, lever 130, and the shutter 80 to ascend to their previous position in the non-activated mode, whereby the shutter 80 is aligned between the bottom of the hollow compartment 60 and the dispensing aperture 70 to prevent the pellets from being dispensed through the dispensing aperture 70, as shown in FIG. 2. It is preferable that the shutter 80 be slanted in a direction away from the container body 10 and/or toward the user to facilitate easier dispensing of the pellets. Additionally, those skilled in the art will recognize that the slant angle of the shutter 80 may be increased to allow the pellets to be dispensed more rapidly or decreased to allow the pellets to be dispensed less rapidly to the user.

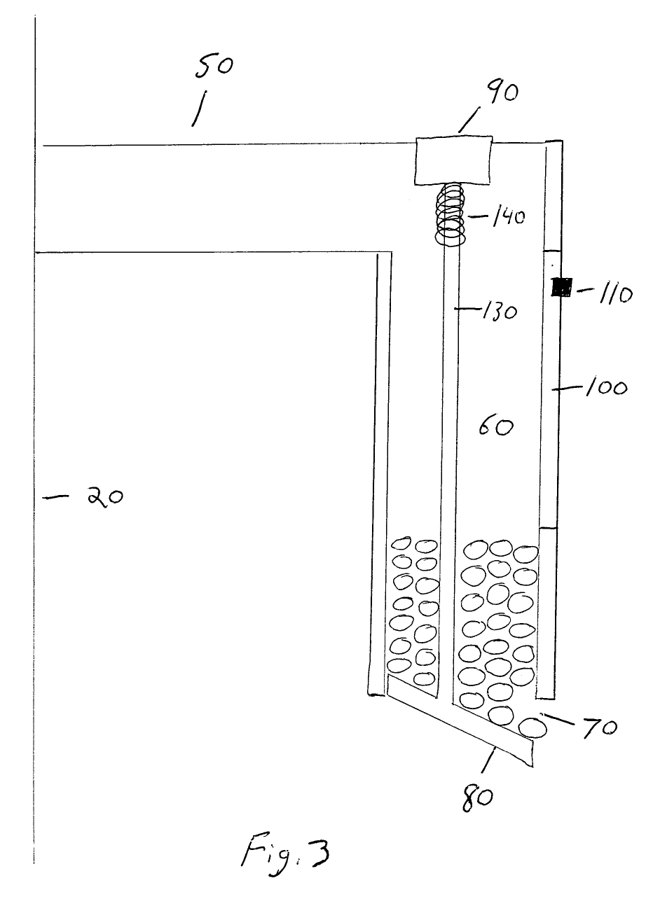

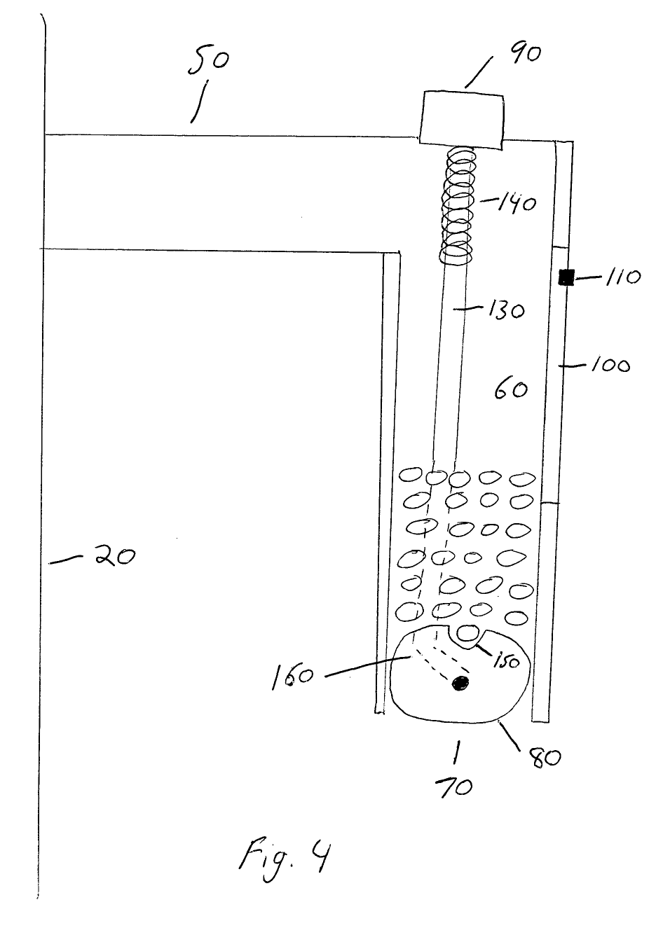

In an alternate embodiment, the shutter 80 is a circular wheel 80 disposed, in the handle 50, between the bottom of the hollow compartment 60 and the dispensing aperture 70 to prevent the pellets from being dispensed through the dispensing aperture 70. The wheel 80 has a concave groove 150 to allow one or more pellets in the hollow compartment 60 to be stored within the groove 150, as shown in FIG. 4. The wheel 80 is configured to rotate on an axel 160 which is coupled to a lever 130 within the handle 50. The lever 130, in turn, is coupled to an actuator 90, such as a button, located at the top of the handle 50. A spring 140 is also coupled to the actuator 90 and fits around the lever 130. In the non-activated mode of the present embodiment, as shown in FIG. 4, the wheel 80 is positioned so that the groove 150 is facing upward toward the top of the handle 50 to allow one or more pellets to be stored within the groove 150. The spring 140 is configured to compress to allow the user to press down on the actuator 90. When the user presses down on the actuator 90, the lever 130 descends and forces the axel 160 to rotate and turn the wheel 180° so that the groove 150 is facing downward toward the dispensing aperture 70 at the bottom of the handle 50. This allows the one or more pellets stored in the groove 150 of the wheel 80 to be dispensed to the user through the dispensing aperture 70 at the bottom of the handle 50, leaving the groove 150 empty. The present embodiment is now in the activated mode, as shown in FIG. 5. When the user ceases to press down on the actuator 90, the spring 140 decompresses, and forces the actuator 90 and lever 130 to ascend to their previous position in the non-activated mode, thereby returning the axel 160 and wheel 80 to their previous position in the non-activated mode, so that the groove 150 is facing upward toward the top of the handle 50 to allow another one or more pellets can be stored within the groove 150, as shown in FIG. 4. Additionally, those skilled in the art will recognize that the size and shape of the wheel 80, along with the number of grooves 150, shape of the grooves 150, and size of the grooves 150 within the wheel 80 may be varied to allow a larger or smaller number of pellets to be dispensed at a time.

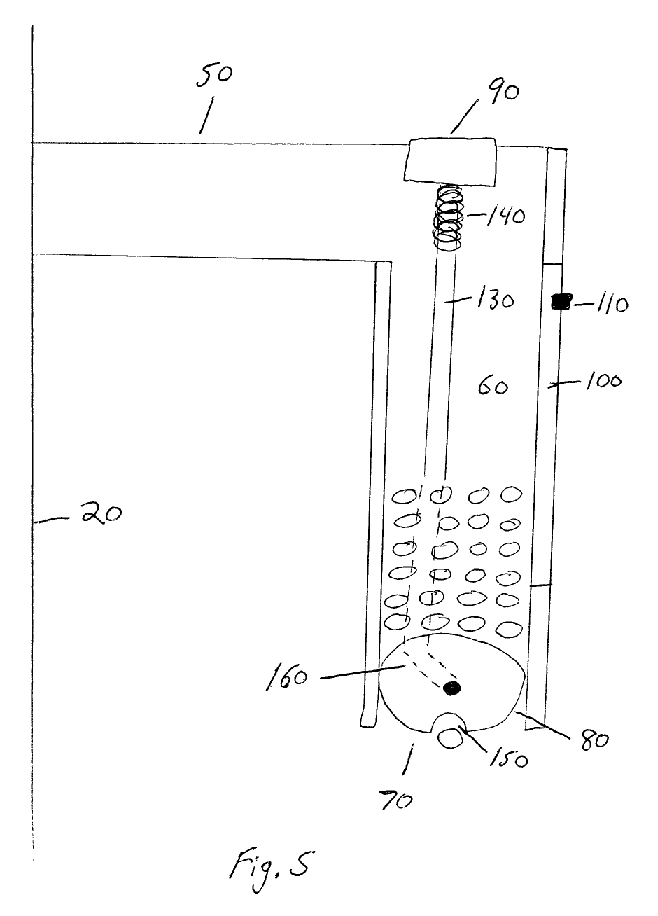

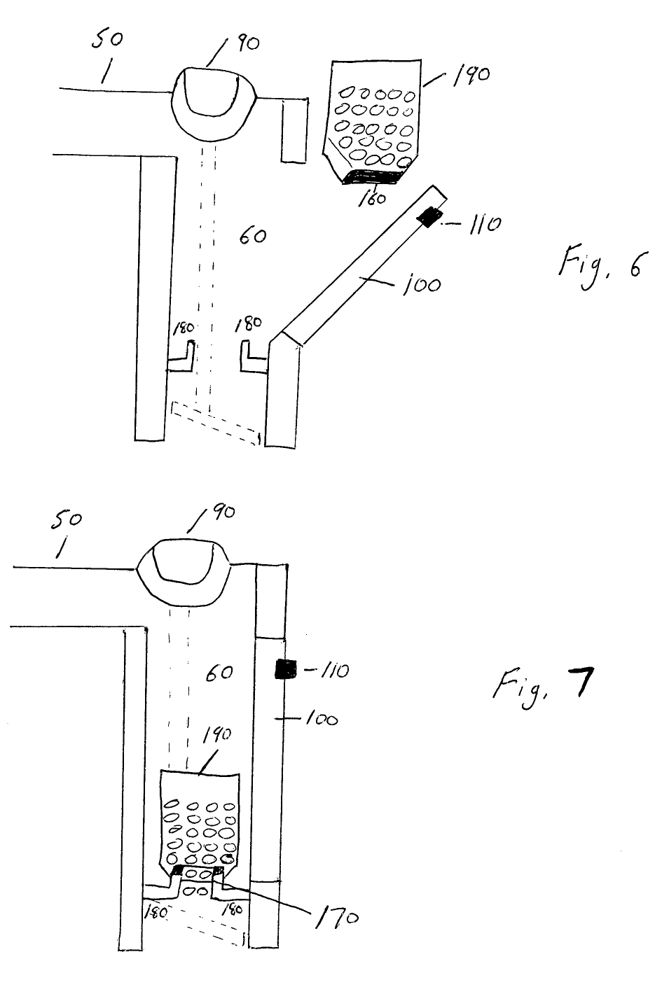

In alternate embodiments, the pellets may be loaded into the handle 50 via a loading cartridge 190 that is configured to snap fit within the hollow compartment 60 of the handle 50 via one or more loading brackets 180 extending from the handle 50 into the hollow compartment 60, as shown in FIG. 6. The user may purchase a loading cartridge 190 which contains a plurality of pellets, such as mints or gum. A cartridge aperture 170 is located at the bottom of the loading cartridge 190 to allow the pellets to be dispensed from the bottom of the loading cartridge 190. The cartridge aperture 170 is temporarily covered with a cartridge seal 160, such as a piece of foil. The user opens the loading door 100 on the outside of the handle 50 exposing the hollow compartment 60 within the handle 50. The user snap fits the loading cartridge 190 into the hollow compartment 60 of the handle 50, via the loading brackets 180, thereby puncturing the cartridge seal 160, exposing the cartridge aperture 160, as shown in FIG. 7. The loading cartridge 190 is configured to allow the cartridge aperture 170 to be aligned with the dispensing aperture 70 at the bottom of the handle 50, after it is snap fit into the hollow compartment 60 via the loading brackets 180. The user then closes the loading door 100 on the handle 50 to keep the loading cartridge 190 within the hollow compartment 60 of the handle 50. The pellets in the loading cartridge 190 may now be released to the user by pressing down on the actuator 90 to change the position of the shutter 80 so that it is no longer disposed between the cartridge aperture 170 and the dispensing aperture 70 at the bottom of the handle 50.

In alternate embodiments, the user may remove the cartridge seal 160, exposing the cartridge aperture 170, prior to placing the loading cartridge 190 into the hollow compartment 60 within the handle 50.

Additionally, in alternate embodiments of the present invention, an insulating layer, such as rubber, may be disposed on the inside or the outside of the container body 10 to prevent a hot or warm beverage contained within the container body 10 from melting the pellets or otherwise affecting the shape or composition of the pellets being stored within the handle 50. Further, an insulating layer may instead or additionally be disposed on the inside or outside of the handle 50, or the loading cartridge 190. It is to be understood that the insulating layer may be of any insulating material known in the art and disposed in any manner, known in the art, within or around any of the aforementioned components to accomplish the purpose of preventing the temperature of the beverage stored in the container body 10 from affecting the shape, state, and composition of the pellets stored within the handle 50.

Those skilled in the art will recognize that the foregoing is considered merely illustrative of the principles of the invention. Since numerous modifications and changes will readily occur to those skilled in the art, it is not desired to limit the above embodiments of the present invention to the exact construction and operation shown and described. For example, it is to be realized the shape and dimensional relationships for the components of the invention will include variations in size, shape, materials, form, assembly, function, and manner of operation and use. Additionally, it is to be realized that the dispensing aperture 70, shutter 80, actuator 90, loading door 100, loading cartridge 190, along with any additional components discussed herein, may be located at a variety of different positions on or within the handle of the beverage container to allow one skilled in the art to achieve the functionality encompassed by the present invention. Such modifications and changes are deemed readily apparent to those skilled in the art, and thus intended to be encompassed by the present invention.

1. A beverage container comprising:
a container body having one or more side walls and a bottom wall defining a storage area, said container body also having an open end for receiving a beverage to be contained within said container body;
a handle, coupled to said one or more side walls, having a compartment for storing one or more pellets within said handle;
a dispensing aperture in said handle for allowing the dispensing of said one or more pellets; and
a shutter disposed in said handle aligned between said compartment and said dispensing aperture, wherein said shutter is configured to open to allow the dispensing of said one or more pellets and to close to prevent the dispensing of said one or more pellets from said compartment within said handle.

2. The beverage container of claim 1, wherein said container body has a substantially cylindrical shape.

3. The beverage container of claim 1, wherein said dispensing aperture is located at the bottom end of said handle.

4. The beverage container of claim 1, wherein said dispensing aperture is located along the side of said handle.

5. The beverage container of claim 1, wherein said handle includes a loading door to allow the loading of said one or more pellets into said compartment within said handle.

6. The beverage container of claim 5, further comprising a removable cartridge for storing said one or more pellets, said cartridge having a cartridge aperture, wherein said cartridge may be loaded into said compartment within said handle to allow dispensing of said one or more pellets.

7. The beverage container of claim 6, wherein said cartridge has a removable seal covering said cartridge aperture that may be removed by a user to allow the dispensing of said one or more pellets from said cartridge through said cartridge aperture.

8. The beverage container of claim 6, wherein said cartridge snap fits into loading brackets within said compartment of said handle to ensure said cartridge aperture is aligned with said dispensing aperture in said handle.

9. The beverage container of claim 1, wherein said handle further includes an insulating layer to prevent temperature of said beverage contained within said container body from changing the shape, state, or composition of said one or more pellets stored within said handle.

10. The beverage container of claim 1, wherein said container body further includes an insulating layer to prevent temperature of said beverage contained within said container body from changing the shape, state, or composition of said one or more pellets stored within said handle.

11. The beverage container of claim 6, wherein said cartridge further includes an insulating layer to prevent temperature of said beverage contained within said container body from changing the shape, state, or composition of said one or more pellets stored within said handle.

12. The beverage container of claim 1, wherein said container body further includes a cover disposed on said open end of said container body.

13. The beverage container of claim 12, wherein said cover has an aperture to allow the dispensing of said beverage from said container body.

14 The beverage container of claim 13, wherein said cover is removable to allow said beverage to be received within said storage area of said container body.

15. The beverage container of claim 1, wherein said shutter is configured to slide back and forth to allow and prevent the dispensing of said one or more pellets.

16. A beverage container comprising:
a container body having one or more side walls and a bottom wall defining a storage area, said container body also having an open end for receiving a beverage to be contained within said container body;
a handle, coupled to said one or more side walls, having a compartment for storing one or more pellets within said handle;
a dispensing aperture in said handle for allowing the dispensing of said one or more pellets;
a shutter disposed in said handle aligned between said compartment and said dispensing aperture to prevent the dispensing of said one or more pellets; and
an actuator coupled to said shutter, wherein said actuator may be depressed to cause said shutter to change position to allow dispensing of said one or more pellets from said compartment within said handle.

17. The beverage container of claim 16, wherein said container body has a substantially cylindrical shape.

18. The beverage container of claim 16, wherein said dispensing aperture is located at the bottom end of said handle and said actuator is located at the top end of said handle.

19. The beverage container of claim 16, wherein said dispensing aperture is located along the side of said handle and said actuator is located at the top end of said handle.

20. The beverage container of claim 16, wherein said shutter is configured to slide back and forth to allow and prevent the dispensing of said one or more pellets.

21 The beverage container of claim 18, wherein said shutter is coupled to said actuator via a lever, and wherein said actuator may be depressed to cause said shutter to descend to allow dispensing of said one or more pellets from said compartment within said handle.

22. The beverage container of claim 18, wherein said shutter is circular wheel having one or more grooves to store said one or more pellets, said shutter coupled to said actuator via a lever and axel, and wherein said actuator may be depressed to cause said shutter to rotate to allow dispensing of said one or more pellets from said compartment within said handle.

23. The beverage container of claim 16, wherein said handle includes a loading door to allow the loading of said one or more pellets into said compartment within said handle.

24. The beverage container of claim 23, further comprising a removable cartridge for storing said one or more pellets, said cartridge having a cartridge aperture, wherein said cartridge may be loaded into said compartment within said handle to allow dispensing of said one or more pellets.

25. The beverage container of claim 24, wherein said cartridge has a removable seal covering said cartridge aperture that may be removed by a user to allow the dispensing of said one or more pellets from the cartridge through said cartridge aperture.

26. The beverage container of claim 24, wherein said cartridge snap fits into loading brackets within said compartment of said handle to ensure said cartridge aperture is aligned with said dispensing aperture in said handle.

27. The beverage container of claim 16, wherein said handle further includes an insulating layer to prevent temperature of said beverage contained within said container body from changing the shape, state, or composition of said one or more pellets stored within said handle.

28. The beverage container of claim 16, wherein said container body further includes an insulating layer to prevent temperature of said beverage contained within said container body from changing the shape, state, or composition of said one or more pellets stored within said handle.

29. The beverage container of claim 21, wherein said cartridge further includes an insulating layer to prevent temperature of said beverage contained within said container body from changing the shape, state, or composition of said one or more pellets stored within said handle.

30. The beverage container of claim 16, wherein said container body further includes a cover disposed on said open end of said container body.

31. The beverage container of claim 30, wherein said cover has an aperture to allow the dispensing of said beverage from said container body.

32 The beverage container of claim 31, wherein said cover is removable to allow said beverage to be received within said storage area of said container body.
